(19) United States
(12) Patent Application Publication
(10) Pub. No.: US 2025/0335396 A1
(43) Pub. Date: Oct. 30, 2025

(54) FILE STORAGE METHOD, DEVICE, AND STORAGE MEDIUM

(71) Applicant: Beijing Volcano Engine Technology Co., Ltd., Beijing (CN)

(72) Inventor: Baiwan ZHU, Beijing (CN)

(21) Appl. No.: 18/983,368

(22) Filed: Dec. 17, 2024

(30) Foreign Application Priority Data
Apr. 25, 2024 (CN) 202410505151.6

(51) Int. Cl. G06F 16/13

(52) U.S. Cl. CPC G06F 16/13

(57) ABSTRACT

Embodiments of the present disclosure provide a file storage method, a device, and a storage medium. The method includes: in response to receiving an upload request for a target file, determining a target folder where the target file is located, and determining storage configuration information corresponding to the target folder from storage configuration information corresponding to multiple folders that are pre-configured, the storage configuration information including storage size configuration information, model configuration information and storage path; performing a shard process on the target file according to the storage size configuration information to obtain multiple shards corresponding to the target file; storing the multiple shards corresponding to the target file into a relationship database, determining vectors corresponding to the multiple shards respectively according to the model configuration information, and storing the vectors corresponding to the multiple shards respectively into a vector database according to the storage path configuration information.

### CROSS-REFERENCE TO RELATED APPLICATION(S)

The application claims priority to the Chinese patent application No. 202410505151.6, filed on Apr. 25, 2024, the entire disclosure of which is incorporated herein by reference as part of the present application.

### TECHNICAL FIELD

Embodiments of the present disclosure relate to the field of artificial intelligence technology, and in particular, to a file storage method and apparatus, a device, and a storage medium.

### BACKGROUND

With the development of artificial intelligence technology, more and more users obtain knowledge or answer questions from vector databases through artificial intelligence platforms, and before the application of the vector databases, relevant vectors need to be stored into vector databases.

In prior arts, to store these vectors, at least two important components are needed, one component is used to obtain the original material, and then convert the original material into vectors, and the other component is used to store the converted vectors into the vector database.

However, the inventors found that the prior art has at least the following technical problems: the vectors stored in the vector database rely on manual processing for uploading, which leads to a low storage efficiency of files.

### SUMMARY

Embodiments of the present disclosure provide a file storage method and apparatus, a device, and a storage medium, which can improve the storage efficiency of files.

In a first aspect, an embodiment of the present disclosure provides a file storage method, including:

in response to receiving an upload request for a target file, determining a target folder in which the target file is located, and determining storage configuration information corresponding to the target folder from storage configuration information corresponding to multiple folders that are pre-configured, wherein the storage configuration information comprises storage size configuration information for configuring a storage size of a file, model configuration information for configuring a vectorization model of the file, and storage path configuration information for configuring a storage path of the file;

performing a shard process on the target file according to the storage size configuration information to obtain multiple shards corresponding to the target file; and

storing the multiple shards corresponding to the target file into a relationship database, determining vectors corresponding to the multiple shards respectively according to the model configuration information, and storing the vectors corresponding to the multiple shards respectively into a vector database according to the storage path configuration information.

In a second aspect, an embodiment of the present disclosure provides a file storage apparatus, including:

an obtaining module, configured to, in response to receiving an upload request for a target file, determine a target folder in which the target file is located, and determine storage configuration information corresponding to the target folder from storage configuration information corresponding to multiple folders that are pre-configured, in which the storage configuration information comprises storage size configuration information for configuring a storage size of a file, model configuration information for configuring a vectorization model of the file, and storage path configuration information for configuring a storage path of the file;

a determination module, configured to perform a shard process on the target file according to the storage size configuration information to obtain multiple shards corresponding to the target file; and

a storage module, configured to store the multiple shards corresponding to the target file into a relationship database, determine vectors corresponding to the multiple shards respectively according to the model configuration information, and store the vectors corresponding to the multiple shards respectively into a vector database according to the storage path configuration information.

In a third aspect, an embodiment of the present disclosure provides an electronic device, including:

a processor, and a memory communicatively connected to the processor;

the memory stores computer execution instructions; and

the processor executes the computer execution instructions stored in the memory to implement the file storage method according to the above first aspect.

In a fourth aspect, an embodiment of the present disclosure provides a computer-readable storage medium, the computer-readable storage medium stores computer execution instructions, and upon a processor executing the computer execution instructions, the file storage method according to the above first aspect is implemented.

In a fifth aspect, an embodiment of the present disclosure provides a computer program product, including a computer program, upon the computer program being executed by a processor, the file storage method according to the above first aspect is implemented.

Embodiments provide a file storage method and apparatus, a device, and a storage medium. The method includes: in response to receiving an upload request for a target file, determining a target folder in which the target file is located, and determining storage configuration information corresponding to the target folder from storage configuration information corresponding to multiple folders that are pre-configured, in which the storage configuration information comprises storage size configuration information for configuring a storage size of a file, model configuration information for configuring a vectorization model of the file, and storage path configuration information for configuring a storage path of the file; performing a shard process on the target file according to the storage size configuration information to obtain multiple shards corresponding to the target file; and storing the multiple shards corresponding to the target file into a relationship database, determining vectors corresponding to the multiple shards respectively according to the model configuration information, and storing the vectors corresponding to the multiple shards respectively into a vector database according to the storage path configuration information. In the embodiments of the present disclosure, when an upload request for a file is received, after the shard process is performed on the file, vectors corresponding to multiple shards are determined through storage configuration information corresponding to a target folder, and the file and the vectors corresponding to the file are stored at the same time. In this way, the file and the vectors corresponding to the file can be stored with only one shard process, and compared with the prior art, in the process of obtaining the vectors, there is no need to perform a shard process on the file separately, thus improving the storage efficiency of the file. Moreover, the vectors corresponding to the file can be stored into the vector database when the file is uploaded, which improves the update efficiency of the vector database.

### BRIEF DESCRIPTION OF DRAWINGS

In order to illustrate the technical solutions in the embodiments of the present disclosure or in the prior art more clearly, the drawings used in the description of the embodiments or the prior art will be briefly introduced below. Obviously, the drawings in the following description are some embodiments of the present disclosure. For those of ordinary skill in the art, other drawings can be obtained from these drawings without paying any creative labor.

FIG. 1 is a schematic diagram of an application scenario of a file storage method provided by some embodiments of the present disclosure;

FIG. 2 is a flowchart of a file storage method provided by some embodiments of the present disclosure;

FIG. 3 is a schematic diagram of a file storage method provided by some embodiments of the present disclosure;

FIG. 4 is a flowchart of a file storage method provided by some embodiments of the present disclosure;

FIG. 5 is a flowchart of a vector update method provided by some embodiments of the present disclosure;

FIG. 6 is a flowchart of a vector search method provided by some embodiments of the present disclosure;

FIG. 7 is a structural block diagram of a file storage apparatus provided by some embodiments of the present disclosure; and

FIG. 8 is a schematic diagram of a hardware structure of an electronic device provided by some embodiments of the present disclosure.

### DETAILED DESCRIPTION

In order to make the objectives, technical solutions and advantages of the embodiments of the present disclosure clearer, the technical solutions in the embodiments of the present disclosure will be described clearly and completely with reference to the drawings in the embodiments of the present disclosure. Obviously, the described embodiments are part of the embodiments of the present disclosure, rather than all of them. Based on the embodiments in the present disclosure, all other embodiments obtained by those of ordinary skill in the art without creative efforts fall within the protection scope of the present disclosure.

It should be noted that the user information (including but not limited to user equipment information, user personal information, etc.) and data (including but not limited to data for analysis, stored data, displayed data, etc.) involved in this application are information and data authorized by users or fully authorized by parties, and the collection, use and processing of related data need to comply with relevant laws, regulations and standards, and provide corresponding operation entry for users to choose authorization or refusal.

With the development of artificial intelligence technology, more and more users obtain knowledge or answer questions from vector databases through artificial intelligence platforms, and before the application of the vector databases, relevant vectors need to be stored into the vector databases.

In prior arts, to store these vectors, at least two important components are needed, one component is used to obtain the original material, and then convert the original material into vectors, and the other component is used to store the converted vectors into the vector database.

However, the vectors stored in the vector database rely on manual processing for uploading, which leads to low storage efficiency of files.

In prior arts, the processing process of these data is roughly as follows: a user uploads an original file, which is assumed to be a PDF file, to a server database (for example, an object storage database) corresponding to an application on XX application, and during this process, a shard process needs to be performed on the original file first to obtain multiple shards. Then the multiple shards are stored into the object storage database. When a vector of a certain file needs to be stored, the application takes out the file from the server database, performs a shard process on the file to obtain multiple shards, transmits the multiple shards corresponding to the file to a large model with vector conversion capability, and obtains a vector of each shard corresponding to the file. Then the vector of each slice corresponding to this file is transmitted to the vector database for storage.

In the above prior art, in the process of transmitting the file to the server database corresponding to the application, a shard process needs to be performed on the file once. When a vector of a certain file needs to be stored, a shard process needs to be performed on the file again, that is, shard processes needs to be performed on the file twice, which consumes more storage time, so the storage efficiency of the file is low.

It can be seen that how to improve the storage efficiency of files is a technical problem that needs to be solved urgently.

In order to solve the above problems, the present embodiment proposes the following technical concept: performing a shard process on the file only once, and storing the file and the vector corresponding to the file at the same time, so as to improve the efficiency of storing the file.

Specific steps may include: first, in response to receiving an upload request for a target file, determining a target folder in which the target file is located, and determining storage configuration information corresponding to the target folder from storage configuration information corresponding to multiple folders that are pre-configured. Then, performing a shard process on the target file according to the storage size configuration information to obtain multiple shards corresponding to the target file. Finally, storing the multiple shards corresponding to the target file into a relationship database, and determining vectors corresponding to the multiple shards respectively according to the model configuration information, and storing the vectors corresponding to the multiple shards respectively into a vector database according to the storage path configuration information.

In this case, when an upload request for a file is received, after the shard process is performed on the file, vectors corresponding to multiple shards are determined through storage configuration information corresponding to the target folder, and the file and the vectors corresponding to the file are stored at the same time. In this way, the file and the vectors corresponding to the file can be stored with only one shard process, and compared with the prior art, in the process of obtaining vectors, there is no need to perform a shard process on the file separately, thus improving the storage efficiency of the file. Moreover, the vectors corresponding to the file can be stored into the vector database when the file is uploaded, which improves the update efficiency of the vector database.

The following will explain the application scenarios of the embodiments of the present disclosure:

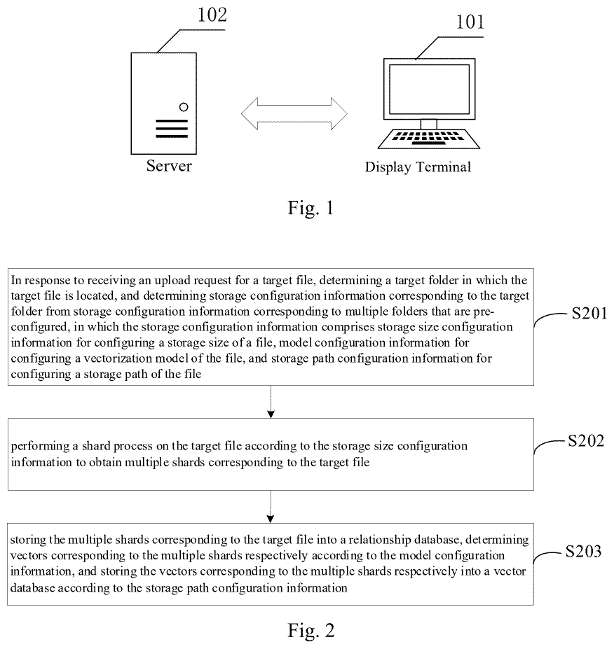

The file storage method provided by the embodiments of the present disclosure can be applied to application scenarios where vectors of files of various formats are stored. For example, files uploaded by users can be stored through an artificial intelligence APP on a mobile terminal or a computer terminal. FIG. 1 is a schematic diagram of an application scenario of a file storage method provided by some embodiments of the present disclosure. As shown in FIG. 1, the display terminal 101 is communicatively connected to the server 102 through wired or wireless means, and a user can transmit file data of any format to the server 102 through the display terminal 101. Exemplarily, a user sends an upload request for a target file to the server 102 through the display terminal 101. The server 102 receives the upload request for the target file, and stores the target file into a relationship database according to the file storage method provided by the embodiments of the present disclosure, and at the same time, determines a vector corresponding to the target file, and stores the vector into a vector database.

The following will give a detailed description of the file storage method provided by the embodiments of the present disclosure with detailed embodiments.

FIG. 2 is a flowchart of a file storage method provided by some embodiments of the present disclosure. In the present embodiment, a server is taken as an example of the execution subject of the file storage method for description. Referring to FIG. 2, the method includes the following steps.

S201: in response to receiving an upload request for a target file, determining a target folder in which the target file is located, and determining storage configuration information corresponding to the target folder from storage configuration information corresponding to multiple folders that are pre-configured, in which the storage configuration information comprises storage size configuration information for configuring a storage size of a file, model configuration information for configuring a vectorization model of the file, and storage path configuration information for configuring a storage path of the file.

In the embodiments of the present disclosure, the target file may be any type of file such as a text file, an image file, an audio file, a video file, and the like.

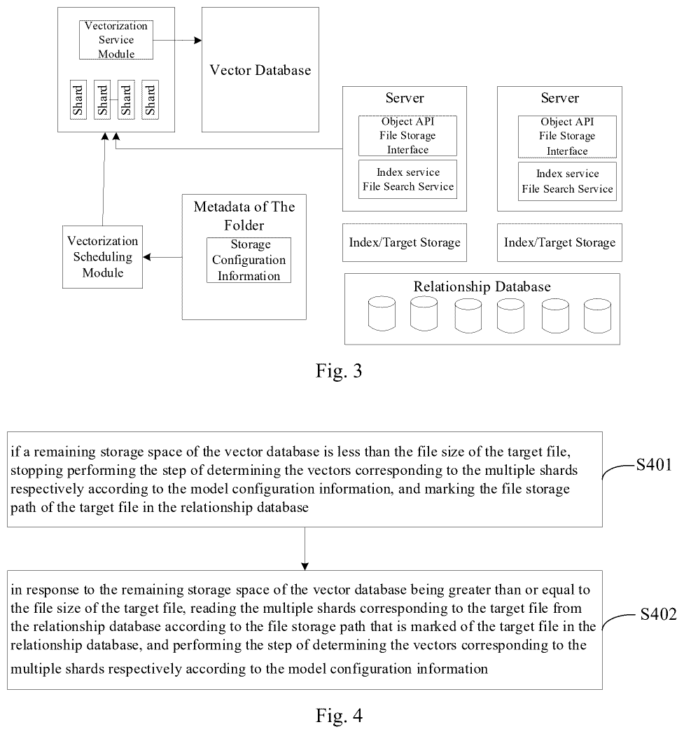

In some embodiments, as shown in FIG. 3, one folder information corresponds to one piece of storage configuration, and the storage configuration information corresponding to the multiple folders may be pre-configured. Optionally, one folder corresponds to one folder identifier, and the storage configuration information corresponding to the multiple folders may be configured by establishing an association relationship between the folder identifier and the storage configuration information. The storage configuration information of a folder may be stored in the metadata of the folder.

The types of the multiple folders may include multiple types. Optionally, the types of the multiple folders include a document folder, a picture text folder, a video folder, and an audio folder. In some embodiments, the storage configuration information configured for folders of the same type is the same. In some other embodiments, the storage configuration information corresponding to the multiple folders may be configured in a user-defined manner.

In some embodiments, the storage configuration information includes storage size configuration information, model configuration information, and storage path configuration information. The storage size configuration information is used for configuring a storage size of a file. The model configuration information is used for configuring a vectorization model of the file. The storage path configuration information is used for configuring a storage path of the file.

Optionally, before storing the target file, a shard process needs to be performed on the target file. The storage size configuration information may be used for configuring a size of a shard. Exemplarily, the storage size configuration information may be represented as: ob_storage_embedding_slice: Embedding shard size (256 KB), that is, the size of each shard is 256 KB.

Optionally, the model configuration information is used for configuring a vectorization model for vectorizing a shard. Optionally, vectorization models corresponding to shards in different formats are different. For example, a text shard and a video shard correspond to different vectorization models. The vectorization model may be represented as an Embedding algorithm or an Embedding model.

Exemplarily, the model configuration information may be represented as: ob_storage_embedding_alg: Embedding algorithm selection. The model configuration information is used for configuring the vectorization model (for example, the Embedding algorithm) for vectorizing a shard.

Optionally, the storage path configuration information is used for configuring a storage path of the target file. Optionally, the storage path includes a database table and a corresponding vector column. Exemplarily, the database table in the storage path may be represented as: ob_storage_instance_table: Embedding corresponding database table. The vector column in the storage path may be represented as: ob_storage_instance_table_column: Embedding corresponding vector column.

In some other embodiments, the storage configuration information may further include one or more selected from a group consisting of storage mode configuration information, storage time configuration information, a file identifier of the target file, a file size of the target file, a file storage path of the target file in the relationship database, an update time of the target file, and a file type of the target file.

Optionally, the storage mode configuration information is used for representing whether the vector corresponding to the file needs to be stored. Exemplarily, the storage mode configuration information is: ob_storage_bucket_flag: Embedding sign, which is used for representing that the vector corresponding to the file needs to be stored.

S202: performing a shard process on the target file according to the storage size configuration information to obtain multiple shards corresponding to the target file.

In some embodiments, as shown in FIG. 3, the server may include a file storage interface, and the file storage interface may perform the shard process on the target file according to the storage size configuration information to obtain the multiple shards corresponding to the target file. The file storage interface may be represented as Object API.

Exemplarily, the target file is an XX document with a size of 1024 KB. The storage size configuration information is 256 KB. The file storage interface performs the shard process on the target file according to the storage size configuration information to obtain multiple shards corresponding to the target file which are respectively S1 (256 KB), S2 (256 KB), S3 (256 KB), and S4 (256 KB).

S203: storing the multiple shards corresponding to the target file into a relationship database, determining vectors corresponding to the multiple shards respectively according to the model configuration information, and storing the vectors corresponding to the multiple shards respectively into a vector database according to the storage path configuration information.

In some embodiments, as shown in FIG. 3, the model configuration information may be called through a vectorization service module, and the vectors corresponding to the multiple shards respectively are determined according to the model configuration information. The vectorization service module may be represented as Embedding service module.

It can be understood that the relationship database is a database for storing and querying files, and the vector database is a database for storing and querying vectors. Optionally, as shown in FIG. 3, a server corresponding to the relationship database may include a file storage interface and a file search service, the file storage interface is used to store files into the relationship database, and the file search service is used to search for files stored in the relationship database. Exemplarily, the file storage interface may be represented as Object API, and the file search service may be represented as Index service.

Optionally, the model configuration information may include a vectorization model for vectorizing the multiple shards. The vectorization model may map high-dimensional data (such as a text, a picture, a video) to a low-dimensional continuous vector space.

It should be noted that after vectors corresponding to the multiple shards are determined, sharp data may be discarded, and vectors corresponding to the multiple shards are stored into the vector database.

In some embodiments, the vector database includes multiple database tables, and each database table includes multiple vector columns; accordingly, storing the vectors corresponding to the multiple shards respectively into the vector database according to the storage path configuration information includes: determining a target database table from the multiple database tables included in the vector database according to a database table identifier in the storage path configuration information; and determining a target vector column from the multiple vector columns included in the target database table according to a vector column identifier in the storage path configuration information, and storing the vectors corresponding to the multiple shards respectively into the target vector column.

Optionally, the storage configuration information corresponding to the target folder further includes storage mode configuration information for configuring a storage mode of the file; accordingly, before determining the vectors corresponding to the multiple shards respectively according to the model configuration information, the method further includes: if the storage mode configuration information is used to represent that the vectors corresponding to the file need to be stored, performing the step of determining the vectors corresponding to the multiple shards respectively according to the model configuration information; and if the storage mode configuration information is used to represent that the vectors corresponding to the file do not need to be stored, no longer performing the step of determining the vectors corresponding to the multiple shards respectively according to the model configuration information.

Exemplarily, as shown in FIG. 3, a server may include a file storage interface, and storage mode configuration information of the target file may be obtained through the file storage interface in the server. If the storage mode configuration information is: Embedding (vectorization), it is represented that the vectors corresponding to the target file needs to be stored, the step of determining the vectors corresponding to the multiple shards respectively according to the model configuration information is performed.

For example, storage configuration information corresponding to a picture folder is: Embedding (vectorization). Storage configuration information corresponding to a video folder is: NO Embedding (no vectorization). In this case, if the storage configuration information of the picture folder in which the target file (for example, picture A) is located requires vectorization, the vectors corresponding to the multiple shards corresponding to the target file (picture A) are determined. If the storage configuration information of the video folder in which the target file (for example, video A) is located does not require vectorization, the step of determining the vectors corresponding to the multiple shards corresponding to the target file (video A) is not performed.

Here, because whether the vector corresponding to the file is stored into the vector database can be flexibly configured through the storage mode configuration information, thereby improving the personalized management of each file, and therefore the user experience is improved.

Embodiments of the present disclosure provide a file storage method which includes: in response to receiving an upload request for a target file, determining a target folder in which the target file is located, and determining storage configuration information corresponding to the target folder from storage configuration information corresponding to multiple folders that are pre-configured; performing a shard process on the target file according to storage size configuration information to obtain multiple shards corresponding to the target file; and storing the multiple shards corresponding to the target file into a relationship database, determining vectors corresponding to the multiple shards respectively according to model configuration information, and storing the vectors corresponding to the multiple shards respectively into a vector database according to storage path configuration information. In the embodiments of the present disclosure, because when an upload request for a file is received, after the shard process is performed on the file, vectors corresponding to multiple shards are determined through storage configuration information corresponding to a target folder, and the file and the vectors corresponding to the file are stored at the same time. In this way, the file and the vectors corresponding to the file can be stored with only one shard process. Compared with the prior art, in the process of obtaining vectors, there is no need to perform a shard process on the file separately, thus improving the storage efficiency of the file. Moreover, the vectors corresponding to the file can be stored into the vector database when the file is uploaded, which improves the update efficiency of the vector database.

It should be noted that in the embodiments of the present disclosure, in the process of vectorizing the shards through the vectorization service module, the shards that have not been vectorized may be cached. If the cache of the vectorization service module is full, the file storage path of the file or shard that has not been cached may be marked, and the shards are continue to be cached and vectorized when the vectorization service module has an idle cache.

In some embodiments, the storage configuration information corresponding to the target folder further includes a file identifier of the target file, a file size of the target file, and a file storage path of the target file in the relationship database; accordingly, as shown in FIG. 4, before determining the vectors corresponding to the multiple shards respectively according to the model configuration information, the method further includes the following steps.

S401: if a remaining storage space of the vector database is less than the file size of the target file, stopping performing the step of determining the vectors corresponding to the multiple shards respectively according to the model configuration information, and marking the file storage path of the target file in the relationship database.

In some embodiments, as shown in FIG. 3, the server may include a vectorization scheduling module. If the remaining storage space of the vector database is less than the file size of the target file, the step of determining the vectors corresponding to the multiple shards respectively according to the model configuration information is stopped, and the file storage path of the target file in the relationship database is marked through the vectorization scheduling module.

S402: in response to the remaining storage space of the vector database being greater than or equal to the file size of the target file, reading the multiple shards corresponding to the target file from the relationship database according to the file storage path that is marked of the target file in the relationship database, and performing the step of determining the vectors corresponding to the multiple shards respectively according to the model configuration information.

In some embodiments, as shown in FIG. 3, in response to the remaining storage space of the vector database being greater than or equal to the file size of the target file, the multiple shards corresponding to the target file are read from the relationship database through the vectorization scheduling module according to the marked file storage path of the target file in the relationship database. The vectorization scheduling module sends the multiple shards to the vectorization service module, and the vectors corresponding to the multiple shards respectively are determined through the vectorization service module according to the model configuration information.

It should be noted that in the embodiments of the present disclosure, the storage configuration information corresponding to the target folder further includes storage time configuration information for configuring a storage time of the file, and the vectors corresponding to the multiple shards respectively are determined according to the storage time configuration information.

Accordingly, determining the vectors corresponding to the multiple shards respectively according to the model configuration information may include the following three cases:

In the first case, if the storage time configuration information is used to represent immediate storage, the vectors corresponding to the multiple shards respectively are directly determined according to the model configuration information.

In the second case, if the storage time configuration information is used to represent storage during idle time, a resource usage rate within a preset time period is obtained, and the vectors corresponding to the multiple shards respectively are determined according to the model configuration information if the resource usage rate within the preset time period is less than a preset usage rate.

In this step, the values of the preset usage rate and the preset time period are not specifically limited. Exemplarily, the preset usage rate may be 50%, 60%, 70%, etc. The preset time period may be 10 minutes, 30 minutes, 50 minutes, etc.

In this step, in the case where the resource usage rate within the preset time period is less than the preset usage rate, that is, in the case where the resource usage rate is less than the preset usage rate, for example, the resource usage rate is less than the preset usage rate in a period more than the preset time period, the vectors corresponding to the multiple shards are determined, which can avoid frequent start and stop of the vectorization due to short-term fluctuations in the resource usage rate, thus improving the stability of data storage.

In the third case, if the storage time configuration information is used to represent user-defined, the vectors corresponding to the multiple shards respectively are determined according to the model configuration information within a preset time period.

The preset time period is not specifically limited in the embodiments of the present disclosure. Exemplarily, the preset time period defined by the user is: every Monday night (for example, 22:00 to 5:00), or every Monday night (for example, 22:00 to 5:00) and every Wednesday night (for example, 22:00 to 5:00).

In the embodiments of the present disclosure, because the time period for storing vectors can be determined through the storage time configuration information, the computing resources that are idle at night can be used to realize tidal scheduling, thereby reducing the overall cost expenditure of the service.

It should be noted that in daily applications, there may be cases where file information in a file needs to be modified and updated. For example, an article, a design drawing, etc. may be modified halfway. The modified file information may be text, some important data and conclusions, or intermediate illustrations, etc. Once these contents are modified, the corresponding vectors should also be modified accordingly. However, according to the current traditional practice, after being modificated, the entire file needs to be re-vectorized, which is very wasteful.

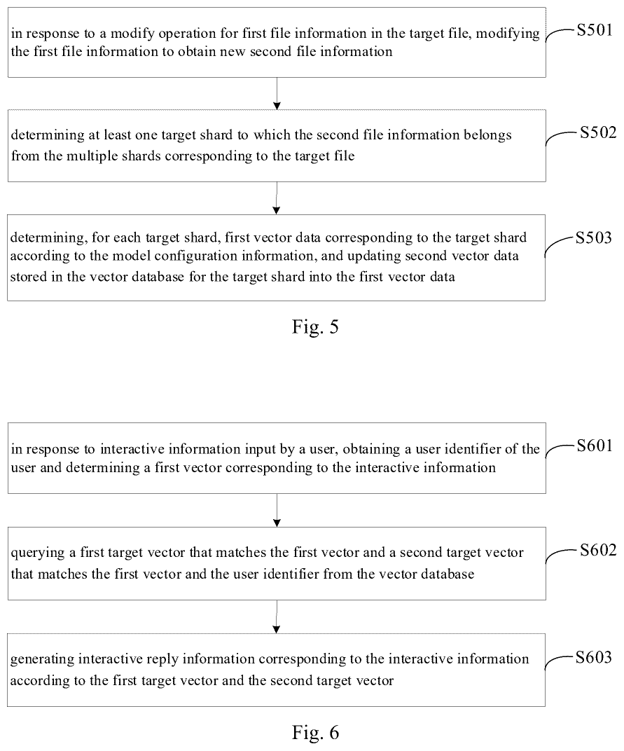

In the present embodiment, for a partially modified file, only a part of the shards in the file need to be re-vectorized, instead of re-vectorizing the entire content of the file. Optionally, the target file includes multiple pieces of file information; accordingly, as shown in FIG. 5, the method further includes the following steps.

S501: in response to a modify operation for first file information in the target file, modifying the first file information to obtain new second file information.

S502: determining at least one target shard to which the second file information belongs from the multiple shards corresponding to the target file.

S503: determining, for each target shard, first vector data corresponding to the target shard according to the model configuration information, and updating second vector data stored in the vector database for the target shard into the first vector data.

In the embodiments of the present disclosure, for a partially modified file, only a part of the shards in the file need to be re-vectorized, which improves the synchronization efficiency of the vector database and the relationship database compared with vectorizing the entire file.

In the embodiments of the present disclosure, after the file is vectorized, vectors may be deduplicated similarly to file deduplication.

In some embodiments, before determining the vectors corresponding to the multiple shards respectively according to the model configuration information, a deduplication process may be performed on the vectors. Optionally, the method for performing the deduplication process on vectors may include: determining whether a file the same as the target file exists in the relationship database; if the file the same as the target file exists in the relationship database, no longer performing the step of determining the vectors corresponding to the multiple shards respectively according to the model configuration information; and if no file the same as the target file exists in the relationship database, performing the step of determining the vectors corresponding to the multiple shards respectively according to the model configuration information.

It should be noted that in current vector databases, vectors corresponding to personal data cannot be stored, which results in limited personalized data that can be improved by vector database. limited personalized data that can be provided by the vector database. For example, when different users input the same question, the answers obtained according to the vector database are the same.

In the embodiments of the present application, when a user uploads a target file, a vector corresponding to the target file is synchronously stored. At this time, the target file may include a personal file and a public file of the user, thus solving the technical problem that the vector database cannot store the vector corresponding to the personal data. In this way, when different users input a same question, an answer more in line with the user's intention can be obtained according to the personal file of the user.

The following will be explained with specific embodiments. Optionally, as shown in FIG. 6, the step of determining interactive reply information through the vector database may include the following steps.

S601: in response to interactive information input by a user, obtaining a user identifier of the user and determining a first vector corresponding to the interactive information.

Exemplarily, the interactive information input by the user is: what papers are there about XX? The user identifier of the user may be: user A.

S602: querying a first target vector that matches the first vector and a second target vector that matches the first vector and the user identifier from the vector database.

Exemplarily, the first target vector that matches the first vector queried from the vector database includes: vector data corresponding to published paper 1. The second target vector that matches the first vector and the user identifier includes: vector data corresponding to paper 2 uploaded by user A.

S603: generating interactive reply information corresponding to the interactive information according to the first target vector and the second target vector.

Exemplarily, the queried first target vector (vector data corresponding to published paper 1) and the second target vector (vector data corresponding to paper 2 uploaded by user A) are converted into files, and the interactive reply information corresponding to the interactive information is obtained as follows: published paper 1 and paper 2 uploaded by user A.

In the embodiments of the present disclosure, because the vector database includes vectors corresponding to personal files and vectors corresponding to public files, personalized search results can be provided for users, thus improving the user experience.

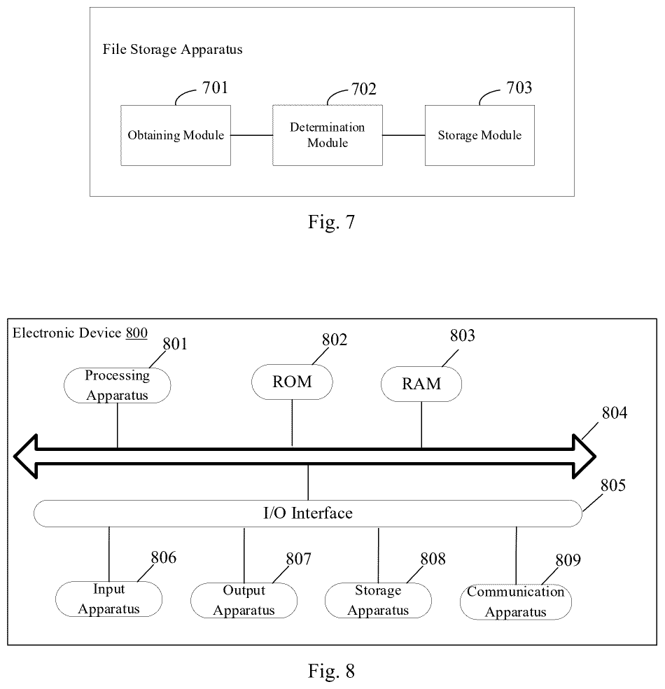

FIG. 7 is a structural block diagram of a file storage apparatus provided by an embodiment of the present disclosure. Referring to FIG. 7, the apparatus includes an obtaining module 701, a determination module 702, and a storage module 703.

The obtaining module 701 is configured to, in response to receiving an upload request for a target file, determine a target folder in which the target file is located, and determine storage configuration information corresponding to the target folder from storage configuration information corresponding to multiple folders that are pre-configured, wherein the storage configuration information comprises storage size configuration information for configuring a storage size of a file, model configuration information for configuring a vectorization model of the file, and storage path configuration information for configuring a storage path of the file;

the determination module 702 is configured to perform a shard process on the target file according to the storage size configuration information to obtain multiple shards corresponding to the target file;

the storage module 703 is configured to store the multiple shards corresponding to the target file into a relationship database, determine vectors corresponding to the multiple shards respectively according to the model configuration information, and store the vectors corresponding to the multiple shards respectively into a vector database according to the storage path configuration information.

According to one or more embodiments of the present disclosure, the vector database includes multiple database tables, and each database table includes multiple vector columns; and accordingly, storing, by the storage module 703, the vectors corresponding to the multiple shards respectively into the vector database according to the storage path configuration information includes: determining a target database table from the multiple database tables included in the vector database according to a database table identifier in the storage path configuration information; and determining a target vector column from the multiple vector columns included in the target database table according to a vector column identifier in the storage path configuration information, and storing the vectors corresponding to the multiple shards respectively into the target vector column.

According to one or more embodiments of the present disclosure, the storage configuration information corresponding to the target folder further includes storage mode configuration information for configuring a storage mode of the file; and accordingly, the storage module 703 is further configured to perform the step of determining the vectors corresponding to the multiple shards respectively according to the model configuration information if the storage mode configuration information is used to represent that the vectors corresponding to the file need to be stored, and no longer perform the step of determining the vectors corresponding to the multiple shards respectively according to the model configuration information if the storage mode configuration information is used to represent that the vectors corresponding to the file do not need to be stored.

According to one or more embodiments of the present disclosure, the storage configuration information corresponding to the target folder further includes storage time configuration information for configuring a storage time of the file; and accordingly, determining, by the storage module 703, the vectors corresponding to the multiple shards respectively according to the model configuration information specifically includes: if the storage time configuration information is used to represent immediate storage, directly determining the vectors corresponding to the multiple shards respectively according to the model configuration information; if the storage time configuration information is used to represent storage during idle time, obtaining a resource usage rate within a preset time period, and determining the vectors corresponding to the multiple shards respectively according to the model configuration information if the resource usage rate within the preset time period is less than a preset usage rate; and if the storage time configuration information is used to represent user-defined, determining the vectors corresponding to the multiple shards respectively according to the model configuration information within a preset time period.

According to one or more embodiments of the present disclosure, the storage configuration information corresponding to the target folder further includes a file identifier of the target file, a file size of the target file, and a file storage path of the target file in the relationship database; and accordingly, the apparatus further includes a storage scheduling module; the storage scheduling module is configured to, if a remaining storage space of the vector database is less than the file size of the target file, stop performing the step of determining the vectors corresponding to the multiple shards respectively according to the model configuration information, and mark the file storage path of the target file in the relationship database; and in response to the remaining storage space of the vector database being greater than or equal to the file size of the target file, read the multiple shards corresponding to the target file from the relationship database according to the marked file storage path of the target file in the relationship database, and perform the step of determining the vectors corresponding to the multiple shards respectively according to the model configuration information.

According to one or more embodiments of the present disclosure, the target file includes multiple pieces of file information; the apparatus further includes an update module, and the update module is configured to, in response to a modify operation for first file information in the target file, modify the first file information to obtain new second file information, determine at least one target shard to which the second file information belongs from the multiple shards corresponding to the target file, and for each target shard, determine first vector data corresponding to the target shard according to the model configuration information, and update second vector data stored in the vector database for the target shard into the first vector data.

According to one or more embodiments of the present disclosure, the apparatus includes a deduplication module, and the deduplication module is configured to, determine whether a file the same as the target file exists in the relationship database, if the file the same as the target file exists in the relationship database, no longer perform the step of determining the vectors corresponding to the multiple shards respectively according to the model configuration information, and if no file the same as the target file exists in the relationship database, perform the step of determining the vectors corresponding to the multiple shards respectively according to the model configuration information.

According to one or more embodiments of the present disclosure, the apparatus further includes an interaction module; the interaction module is configured to, in response to interactive information input by a user, obtain a user identifier of the user and determine a first vector corresponding to the interactive information, query a first target vector that matches the first vector and a second target vector that matches the first vector and the user identifier from the vector database, and generate interactive reply information corresponding to the interactive information according to the first target vector and the second target vector.

Referring to FIG. 8, it shows a schematic structural diagram of an electronic device 800 suitable for implementing the embodiments of the present disclosure. The electronic device 800 may be a terminal device or a server. The terminal device may include, but is not limited to, mobile terminals such as a mobile phone, a notebook computer, a digital broadcast receiver, a personal digital assistant (abbreviated as PDA), a tablet computer, a portable media player (abbreviated as PMP), a vehicle-mounted terminal (such as a vehicle-mounted navigation terminal), etc., and fixed terminals such as a digital TV, a desktop computer, etc. The electronic device shown in FIG. 8 is only an example, and should not bring any limitation to the functions and scope of use of the embodiments of the present disclosure.

As shown in FIG. 8, the electronic device 800 may include a processing apparatus (such as a central processing unit, a graphics processing unit, etc.) 801, which may perform various appropriate actions and processes according to a program stored in a read-only memory (abbreviated as ROM) 802 or a program loaded from a storage apparatus 808 into a random-access memory (abbreviated as RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses can be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a speaker, a vibrator, or the like; a storage apparatus 808 including, for example, a magnetic tape, a hard disk, or the like; and a communication apparatus 809. The communication apparatus 809 may allow the electronic device 800 to perform wireless or wired communication with other devices to exchange data. Although FIG. 8 shows the electronic device 800 with various apparatuses, it should be understood that it is not required to implement or have all of the illustrated apparatuses. More or fewer apparatuses may alternatively be implemented or provided.

In particular, according to the embodiments of the present disclosure, the processes described above with reference to the flowcharts may be implemented as computer software programs. For example, an embodiment of the present disclosure includes a computer program product, which includes a computer program carried on a computer-readable medium, and the computer program includes program codes for executing the methods shown in the flowcharts. In such an embodiment, the computer program may be downloaded and installed from a network through the communication apparatus 809, or installed from the storage apparatus 808, or installed from the ROM 502. When the computer program is executed by the processing apparatus 801, the above-mentioned functions defined in the methods of the embodiments of the present disclosure are executed.

It should be noted that the above-mentioned computer-readable medium in the present disclosure may be a computer-readable signal medium or a computer-readable storage medium or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program codes are carried therein. This propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium may be transmitted by any suitable medium, including but not limited to: a wire, an optical cable, radio frequency (RF), etc., or any suitable combination thereof.

The above-mentioned computer-readable medium may be included in the above-mentioned electronic device, or may exist alone without being assembled into the electronic device.

The above computer-readable medium carries one or more programs, and when the one or more programs are executed by the electronic device, the electronic device is caused to execute the method shown in the above embodiments.

Computer program codes for performing the operations of the present disclosure may be written in one or more programming languages or a combination thereof. The above programming languages include object-oriented programming languages such as Java, Smalltalk, C++, and also include conventional procedural programming languages such as “C” language or similar programming languages. The program code may be executed entirely on the user's computer, partly on the user's computer, as a stand-alone software package, partly on the user's computer and partly on a remote computer, or entirely on the remote computer or server. In the case of a remote computer, the remote computer may be connected to the user's computer through any kind of network, including a local area network (abbreviated as LAN) or a wide area network (abbreviated as WAN), or may be connected to an external computer (for example, connected through the Internet using an Internet service provider).

The flowcharts and block diagrams in the drawings illustrate the architecture, functions and operations of possible implementations of systems, methods and computer program products according to various embodiments of the present disclosure. In this regard, each block in the flowcharts or block diagrams may represent a module, a program segment, or part of codes, which contains one or more executable instructions for implementing specified logic functions. It should also be noted that in some alternative implementations, the functions marked in the blocks may also occur in a different order than the order marked in the drawings. For example, two blocks shown in succession may actually be executed substantially in parallel, and they may sometimes be executed in a reverse order, which depends on the functions involved. It should also be noted that each block in the block diagrams and/or flowcharts, and the combination of blocks in the block diagrams and/or flowcharts, may be implemented by a dedicated hardware-based system that performs specified functions or operations, or may be implemented by a combination of dedicated hardware and computer instructions.

The units described in the embodiments of the present disclosure may be implemented in software or hardware. The name of a unit does not constitute a limitation on the unit itself under certain circumstances. For example, a first obtaining unit may also be described as “a unit for obtaining at least two Internet Protocol addresses”.

The functions described herein above may be executed, at least in part, by one or more hardware logic components. For example, exemplary types of hardware logic components that may be used without limitation include: a field Programmable Gate Array (FPGA), an Application Specific Integrated Circuit (ASIC), an Application Specific Standard Product (ASSP), a System on Chip (SOC), a Complex Programmable Logic Device (CPLD), etc.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In a first aspect, one or more embodiments of the present disclosure provide a file storage method, including:

in response to receiving an upload request for a target file, determining a target folder in which the target file is located, and determining storage configuration information corresponding to the target folder from storage configuration information corresponding to multiple folders that are pre-configured, wherein the storage configuration information comprises storage size configuration information for configuring a storage size of a file, model configuration information for configuring a vectorization model of the file, and storage path configuration information for configuring a storage path of the file;

performing a shard process on the target file according to the storage size configuration information to obtain multiple shards corresponding to the target file; and

storing the multiple shards corresponding to the target file into a relationship database, determining vectors corresponding to the multiple shards respectively according to the model configuration information, and storing the vectors corresponding to the multiple shards respectively into a vector database according to the storage path configuration information.

According to one or more embodiments of the present disclosure, the vector database includes multiple database tables, and each database table includes multiple vector columns. Accordingly, storing the vectors corresponding to the multiple shards respectively into the vector database according to the storage path configuration information includes: determining a target database table from the multiple database tables included in the vector database according to a database table identifier in the storage path configuration information; and determining a target vector column from the multiple vector columns included in the target database table according to a vector column identifier in the storage path configuration information, and storing the vectors corresponding to the multiple shards respectively into the target vector column.

According to one or more embodiments of the present disclosure, the storage configuration information corresponding to the target folder further includes storage mode configuration information for configuring a storage mode of the file. Accordingly, before determining the vectors corresponding to the multiple shards respectively according to the model configuration information, the method further includes: if the storage mode configuration information is used to represent that the vectors corresponding to the file need to be stored, performing the step of determining the vectors corresponding to the multiple shards respectively according to the model configuration information; and if the storage mode configuration information is used to represent that the vectors corresponding to the file do not need to be stored, no longer performing the step of determining the vectors corresponding to the multiple shards respectively according to the model configuration information.

According to one or more embodiments of the present disclosure, the storage configuration information corresponding to the target folder further includes storage time configuration information for configuring a storage time of the file. Accordingly, determining the vectors corresponding to the multiple shards respectively according to the model configuration information includes: if the storage time configuration information is used to represent immediate storage, directly determining the vectors corresponding to the multiple shards respectively according to the model configuration information; if the storage time configuration information is used to represent storage during idle time, obtaining a resource usage rate within a preset time period, and determining the vectors corresponding to the multiple shards respectively according to the model configuration information if the resource usage rate within the preset time period is less than a preset usage rate; and if the storage time configuration information is used to represent user-defined, determining the vectors corresponding to the multiple shards respectively according to the model configuration information within a preset time period.

According to one or more embodiments of the present disclosure, the storage configuration information corresponding to the target folder further includes a file identifier of the target file, a file size of the target file, and a file storage path of the target file in the relationship database; accordingly, before determining the vectors corresponding to the multiple shards respectively according to the model configuration information, the method further includes: if a remaining storage space of the vector database is less than the file size of the target file, stopping performing the step of determining the vectors corresponding to the multiple shards respectively according to the model configuration information, and marking the file storage path of the target file in the relationship database; and in response to the remaining storage space of the vector database being greater than or equal to the file size of the target file, reading the multiple shards corresponding to the target file from the relationship database according to the marked file storage path of the target file in the relationship database, and performing the step of determining the vectors corresponding to the multiple shards respectively according to the model configuration information.

According to one or more embodiments of the present disclosure, the target file includes multiple pieces of file information; the method further includes: in response to a modify operation for first file information in the target file, modifying the first file information to obtain new second file information; determining at least one target shard to which the second file information belongs from the multiple shards corresponding to the target file; and for each target shard, determining first vector data corresponding to the target shard according to the model configuration information, and updating second vector data stored in the vector database for the target shard into the first vector data.

According to one or more embodiments of the present disclosure, before determining the vectors corresponding to the multiple shards respectively according to the model configuration information, the method further includes: determining whether a file the same as the target file exists in the relationship database; if the file the same as the target file exists in the relationship database, no longer performing the step of determining the vectors corresponding to the multiple shards respectively according to the model configuration information; and if no file the same as the target file exists in the relationship database, performing the step of determining the vectors corresponding to the multiple shards respectively according to the model configuration information.

According to one or more embodiments of the present disclosure, the method further includes: in response to interactive information input by a user, obtaining a user identifier of the user and determining a first vector corresponding to the interactive information; querying a first target vector that matches the first vector and a second target vector that matches the first vector and the user identifier from the vector database; and generating interactive reply information corresponding to the interactive information according to the first target vector and the second target vector.

In a second aspect, one or more embodiments of the present disclosure provide a file storage apparatus, including:

an obtaining module, configured to determine, in response to receiving an upload request for a target file, a target folder in which the target file is located, and determine storage configuration information corresponding to the target folder from storage configuration information corresponding to multiple folders that are pre-configured, the storage configuration information including storage size configuration information, model configuration information, and storage path configuration information;

a determination module, configured to perform shard process on the target file according to the storage size configuration information to obtain multiple shards corresponding to the target file; and

a storage module, configured to store the multiple shards corresponding to the target file into a relationship database, determine vectors corresponding to the multiple shards respectively according to the model configuration information, and store the vectors corresponding to the multiple shards respectively into a vector database according to the storage path configuration information.

According to one or more embodiments of the present disclosure, the vector database includes multiple database tables, and each database table includes multiple vector columns; and accordingly, the storing, by the storage module, the vectors corresponding to the multiple shards respectively into the vector database according to the storage path configuration information includes: determining a target database table from the multiple database tables included in the vector database according to a database table identifier in the storage path configuration information; and determining a target vector column from the multiple vector columns included in the target database table according to a vector column identifier in the storage path configuration information, and storing the vectors corresponding to the multiple shards respectively into the target vector column.

According to one or more embodiments of the present disclosure, the storage configuration information corresponding to the target folder further includes storage mode configuration information; and accordingly, the storage module is further configured to perform the step of determining the vectors corresponding to the multiple shards respectively according to the model configuration information if the storage mode configuration information is used to represent that the vectors corresponding to the file need to be stored, and no longer perform the step of determining the vectors corresponding to the multiple shards respectively according to the model configuration information if the storage mode configuration information is used to represent that the vectors corresponding to the file do not need to be stored.

According to one or more embodiments of the present disclosure, the storage configuration information corresponding to the target folder further includes storage time configuration information for configuring a storage time of the file; and accordingly, the determining, by the storage module, the vectors corresponding to the multiple shards respectively according to the model configuration information specifically includes: if the storage time configuration information is used to represent immediate storage, directly determining the vectors corresponding to the multiple shards respectively according to the model configuration information; if the storage time configuration information is used to represent storage during idle time, obtaining a resource usage rate within a preset time period, and determining the vectors corresponding to the multiple shards respectively according to the model configuration information if the resource usage rate within the preset time period is less than a preset usage rate; and if the storage time configuration information is used to represent user-defined, determining the vectors corresponding to the multiple shards respectively according to the model configuration information within a preset time period.

According to one or more embodiments of the present disclosure, the storage configuration information corresponding to the target folder further includes a file identifier of the target file, a file size of the target file, and a file storage path of the target file in the relationship database; and accordingly, the apparatus further includes a storage scheduling module; the storage scheduling module is configured to, if a remaining storage space of the vector database is less than the file size of the target file, stop performing the step of determining the vectors corresponding to the multiple shards respectively according to the model configuration information, and mark the file storage path of the target file in the relationship database, and in response to the remaining storage space of the vector database being greater than or equal to the file size of the target file, read the multiple shards corresponding to the target file from the relationship database according to the marked file storage path of the target file in the relationship database, and perform the step of determining the vectors corresponding to the multiple shards respectively according to the model configuration information.

According to one or more embodiments of the present disclosure, the target file includes multiple pieces of file information. The apparatus further includes an update module. The update module is configured to, in response to a modify operation for first file information in the target file, modify the first file information to obtain new second file information, determine at least one target shard to which the second file information belongs from the multiple shards corresponding to the target file, and for each target shard, determine first vector data corresponding to the target shard according to the model configuration information, and update second vector data stored in the vector database for the target shard into the first vector data.

According to one or more embodiments of the present disclosure, the apparatus includes a deduplication module. The deduplication module is configured to: determine whether a file the same as the target file exists in the relationship database; if the file the same as the target file exists in the relationship database, no longer perform the step of determining the vectors corresponding to the multiple shards respectively according to the model configuration information; and if no file the same as the target file exists in the relationship database, perform the step of determining the vectors corresponding to the multiple shards respectively according to the model configuration information.

According to one or more embodiments of the present disclosure, the apparatus further includes an interaction module; the interaction module is configured to, in response to interactive information input by a user, obtain a user identifier of the user and determine a first vector corresponding to the interactive information; query a first target vector that matches the first vector and a second target vector that matches the first vector and the user identifier from the vector database; and generate interactive reply information corresponding to the interactive information according to the first target vector and the second target vector.

In a third aspect, one or more embodiments of the present disclosure provide an electronic device, including: a processor, and a memory communicatively connected to the processor;

the memory stores computer execution instructions; and

the processor executes the computer execution instructions stored in the memory to implement the file storage method according to the above first aspect and various possible designs of the first aspect.

In a fourth aspect, one or more embodiments of the present disclosure provide a computer-readable storage medium, where the computer-readable storage medium stores computer execution instructions, and upon a processor executing the computer execution instructions, the file storage method according to the above first aspect and various possible designs of the first aspect is implemented.

In a fifth aspect, an embodiment of the present disclosure provides a computer program product, including a computer program, upon the computer program being executed by a processor, the file storage method according to the above first aspect and various possible designs of the first aspect is implemented.

The above description is only preferred embodiments of the present disclosure and an explanation of the applied technical principles. Those skilled in the art should understand that the disclosure scope involved in the present disclosure is not limited to the technical solutions formed by the specific combination of the above technical features, and should also cover other technical solutions formed by any combination of the above technical features or their equivalent features without departing from the above disclosure concept, for example, a technical solution formed by replacing the above features with the technical features with similar functions disclosed in the present disclosure (but not limited to).

In addition, although operations are depicted in a particular order, this should not be understood as requiring these operations to be performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features described in the context of separate embodiments may also be implemented in combination in a single embodiment. Conversely, various features described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only example forms for implementing the claims.

1. A file storage method, comprising:
in response to receiving an upload request for a target file, determining a target folder in which the target file is located, and determining storage configuration information corresponding to the target folder from storage configuration information corresponding to multiple folders that are pre-configured, wherein the storage configuration information comprises storage size configuration information for configuring a storage size of a file, model configuration information for configuring a vectorization model of the file, and storage path configuration information for configuring a storage path of the file;
performing a shard process on the target file according to the storage size configuration information to obtain multiple shards corresponding to the target file; and
storing the multiple shards corresponding to the target file into a relationship database, determining vectors corresponding to the multiple shards respectively according to the model configuration information, and storing the vectors corresponding to the multiple shards respectively into a vector database according to the storage path configuration information.

2. The method according to claim 1, wherein the vector database comprises multiple database tables, and each of the database tables comprises multiple vector columns; and
accordingly, storing the vectors corresponding to the multiple shards respectively into the vector database according to the storage path configuration information comprises:
determining a target database table from the multiple database tables comprised in the vector database according to a database table identifier in the storage path configuration information; and
determining a target vector column from the multiple vector columns comprised in the target database table according to a vector column identifier in the storage path configuration information, and storing the vectors corresponding to the multiple shards respectively into the target vector column.

3. The method according to claim 1, wherein the storage configuration information corresponding to the target folder further comprises storage mode configuration information for configuring a storage mode of the file; and
accordingly, before determining the vectors corresponding to the multiple shards respectively according to the model configuration information, the method further comprises:
if the storage mode configuration information is used to represent that the vectors corresponding to the target file need to be stored, performing a step of determining the vectors corresponding to the multiple shards respectively according to the model configuration information; and
if the storage mode configuration information is used to represent that the vectors corresponding to the target file do not need to be stored, no longer performing the step of determining the vectors corresponding to the multiple shards respectively according to the model configuration information.

4. The method according to claim 1, wherein the storage configuration information corresponding to the target folder further comprises storage time configuration information for configuring a storage time of the file; and
accordingly, determining the vectors corresponding to the multiple shards respectively according to the model configuration information comprises:
if the storage time configuration information is used to represent immediate storage, directly determining the vectors corresponding to the multiple shards respectively according to the model configuration information;
if the storage time configuration information is used to represent storage during idle time, obtaining a resource usage rate within a preset time period, and determining the vectors corresponding to the multiple shards respectively according to the model configuration information if the resource usage rate within the preset time period is less than a preset usage rate; and
if the storage time configuration information is used to represent user-defined, determining the vectors corresponding to the multiple shards respectively according to the model configuration information within a preset time period.

5. The method according to claim 1, wherein the storage configuration information corresponding to the target folder further comprises a file identifier of the target file, a file size of the target file, and a file storage path of the target file in the relationship database; and
accordingly, before determining the vectors corresponding to the multiple shards respectively according to the model configuration information, the method further comprises:
if a remaining storage space of the vector database is less than the file size of the target file, stopping performing a step of determining the vectors corresponding to the multiple shards respectively according to the model configuration information, and marking the file storage path of the target file in the relationship database; and
in response to the remaining storage space of the vector database being greater than or equal to the file size of the target file, reading the multiple shards corresponding to the target file from the relationship database according to the file storage path that is marked of the target file in the relationship database, and performing the step of determining the vectors corresponding to the multiple shards respectively according to the model configuration information.

6. The method according to claim 1, wherein the target file comprises multiple pieces of file information; and the method further comprises:
in response to a modify operation for first file information in the target file, modifying the first file information to obtain new second file information;
determining at least one target shard to which the second file information belongs from the multiple shards corresponding to the target file; and
determining, for each target shard, first vector data corresponding to the target shard according to the model configuration information, and updating second vector data stored in the vector database for the target shard into the first vector data.

7. The method according to claim 1, wherein before determining the vectors corresponding to the multiple shards respectively according to the model configuration information, the method further comprises:
determining whether a file same as the target file exists in the relationship database; and
if the file the same as the target file exists in the relationship database, no longer performing a step of determining the vectors corresponding to the multiple shards respectively according to the model configuration information; and if no file the same as the target file exists in the relationship database, performing the step of determining the vectors corresponding to the multiple shards respectively according to the model configuration information.

8. The method according to claim 1, wherein the method further comprises:
in response to interactive information input by a user, obtaining a user identifier of the user and determining a first vector corresponding to the interactive information;
querying a first target vector that matches the first vector and a second target vector that matches the first vector and the user identifier from the vector database; and
generating interactive reply information corresponding to the interactive information according to the first target vector and the second target vector.

9. An electronic device, comprising: a processor, and a memory communicatively connected to the processor,
wherein the memory stores computer execution instructions;
the processor executes the computer execution instructions stored in the memory to implement a file storage method; and
the file storage method comprises:
in response to receiving an upload request for a target file, determining a target folder in which the target file is located, and determining storage configuration information corresponding to the target folder from storage configuration information corresponding to multiple folders that are pre-configured, wherein the storage configuration information comprises storage size configuration information for configuring a storage size of a file, model configuration information for configuring a vectorization model of the file, and storage path configuration information for configuring a storage path of the file;
performing a shard process on the target file according to the storage size configuration information to obtain multiple shards corresponding to the target file; and
storing the multiple shards corresponding to the target file into a relationship database, determining vectors corresponding to the multiple shards respectively according to the model configuration information, and storing the vectors corresponding to the multiple shards respectively into a vector database according to the storage path configuration information.

10. A computer-readable storage medium, wherein the computer-readable storage medium stores computer execution instructions, and upon a processor executing the computer execution instructions, a file storage method is implemented;
the file storage method comprises:
in response to receiving an upload request for a target file, determining a target folder in which the target file is located, and determining storage configuration information corresponding to the target folder from storage configuration information corresponding to multiple folders that are pre-configured, wherein the storage configuration information comprises storage size configuration information for configuring a storage size of a file, model configuration information for configuring a vectorization model of the file, and storage path configuration information for configuring a storage path of the file;
performing a shard process on the target file according to the storage size configuration information to obtain multiple shards corresponding to the target file; and
storing the multiple shards corresponding to the target file into a relationship database, determining vectors corresponding to the multiple shards respectively according to the model configuration information, and storing the vectors corresponding to the multiple shards respectively into a vector database according to the storage path configuration information.

11. The method according to claim 1, wherein the storage configuration information corresponding to the target folder further comprises storage time configuration information for configuring a storage time of the file; and
accordingly, determining the vectors corresponding to the multiple shards respectively according to the model configuration information comprises:
determining the vectors corresponding to the multiple shards respectively according to the storage time configuration information.

12. The method according to claim 11, wherein determining the vectors corresponding to the multiple shards respectively according to the storage time configuration information comprises:
if the storage time configuration information is used to represent storage during idle time, obtaining a resource usage rate within a preset time period, and determining the vectors corresponding to the multiple shards respectively according to the model configuration information if the resource usage rate within the preset time period is less than a preset usage rate; and
if the storage time configuration information is used to represent user-defined, determining the vectors corresponding to the multiple shards respectively according to the model configuration information within a preset time period.

13. The method according to claim 1, wherein the relationship database is a database for storing and querying files, and the vector database is a database for storing and querying vectors;
a server corresponding to the relationship database comprises a file storage interface and a file search service, the file storage interface is used to store files into the relationship database, the storage mode configuration information of the target file is obtained through the file storage interface, and the file search service is used to search for files stored in the relationship database.

14. The method according to claim 1, wherein after the vectors corresponding to the multiple shards are determined, sharp data is discarded, and the vectors corresponding to the multiple shards are stored into the vector database.

15. The method according to claim 5, wherein the model configuration information is called through a vectorization service module, the model configuration information comprises a vectorization model for vectorizing the multiple shards;
in a process of vectorizing the multiple shards through the vectorization service module, the multiple shards that have not been vectorized are cached; if cache of the vectorization service module is full, the file storage path of the file or the shards that has not been cached is marked, and the shards are continue to be cached and vectorized when the vectorization service module has an idle cache.

16. The method according to claim 2, wherein before determining the vectors corresponding to the multiple shards respectively according to the model configuration information, the method further comprises:
determining whether a file same as the target file exists in the relationship database; and
if the file the same as the target file exists in the relationship database, no longer performing a step of determining the vectors corresponding to the multiple shards respectively according to the model configuration information; and if no file the same as the target file exists in the relationship database, performing the step of determining the vectors corresponding to the multiple shards respectively according to the model configuration information.

17. The method according to claim 3, wherein before determining the vectors corresponding to the multiple shards respectively according to the model configuration information, the method further comprises:
determining whether a file same as the target file exists in the relationship database; and
if the file the same as the target file exists in the relationship database, no longer performing a step of determining the vectors corresponding to the multiple shards respectively according to the model configuration information; and if no file the same as the target file exists in the relationship database, performing the step of determining the vectors corresponding to the multiple shards respectively according to the model configuration information.

18. The method according to claim 4, wherein before determining the vectors corresponding to the multiple shards respectively according to the model configuration information, the method further comprises:
determining whether a file same as the target file exists in the relationship database; and
if the file the same as the target file exists in the relationship database, no longer performing a step of determining the vectors corresponding to the multiple shards respectively according to the model configuration information; and if no file the same as the target file exists in the relationship database, performing the step of determining the vectors corresponding to the multiple shards respectively according to the model configuration information.

19. The method according to claim 2, wherein the method further comprises:
in response to interactive information input by a user, obtaining a user identifier of the user and determining a first vector corresponding to the interactive information;
querying a first target vector that matches the first vector and a second target vector that matches the first vector and the user identifier from the vector database; and
generating interactive reply information corresponding to the interactive information according to the first target vector and the second target vector.

20. The method according to claim 3, wherein the method further comprises:
in response to interactive information input by a user, obtaining a user identifier of the user and determining a first vector corresponding to the interactive information;
querying a first target vector that matches the first vector and a second target vector that matches the first vector and the user identifier from the vector database; and
generating interactive reply information corresponding to the interactive information according to the first target vector and the second target vector.
